(19) United States
(12) Patent Application Publication
(10) Pub. No.: US 2014/0278604 A1
(43) Pub. Date: Sep. 18, 2014

(54) SYSTEMS AND METHODS FOR OFFERING PARTIALLY-REFUNDABLE VOUCHERS FOR GOODS AND SERVICES

(71) Applicant: Price Point Analytics Inc. d/b/a Level Skies, San Francisco, CA (US)

(72) Inventors: Ryan Houck, Fresno, CA (US); Brandon Collins, Berkeley, CA (US)

(73) Assignee: Price Point Analytics Inc. d/b/a Level Skies, San Francisco, CA (US)

(21) Appl. No.: 14/201,765

(22) Filed: Mar. 7, 2014

Related U.S. Application Data
(60) Provisional application No. 61/773,826, filed on Mar. 7, 2013.

(51) Int. Cl. G06Q 20/38; G06Q 30/02; G06Q 10/02

(52) U.S. Cl. CPC G06Q 20/387; G06Q 10/02; G06Q 30/0202
USPC 705/5; 705/39; 705/7.31

(57) ABSTRACT

The present disclosure provides a system for generating a voucher including a voucher value, a refund value, and an expiration date, wherein the voucher value is at least based on information received from a consumer. If the system receives payment information from the consumer for the voucher and the system does not receive confirmation that the purchased voucher was not redeemed by the expiration date, the system will refund the consumer the refund value associated with the voucher.

### CROSS-REFERENCE TO RELATED APPLICATIONS

This application incorporates by reference and claims priority to U.S. Provisional Application 61/773,826 filed on Mar. 7, 2013.

### BACKGROUND OF THE INVENTION

The present subject matter relates generally to a method for the selling of partially refundable vouchers redeemable for goods and services in which it is difficult or costly to return or exchange said goods or services after making a purchase or in which prices change regularly, making planning a purchase difficult.

There are currently many industries in which prices often change for a good or service on a regular basis. In the travel industry for example, prices for flights and hotels change on a daily, even hourly basis. In second hand, or other competitive markets, prices adjust regularly to match supply and demand. In these environments it is not uncommon for a buyer to make a purchase, only to regret the purchase shortly afterwards, at which point there are limited options for backing out of the transaction, and the few available are often costly. The offer of a partially refundable voucher for goods or services addresses this problem by offering means of partial commitment to a purchase. A consumer paying the purchase price of the voucher, as presented by the invention, will maintain the right to refund much of the voucher's purchase price if he or she later decides against redeeming the voucher for its respective good or service.

Accordingly, there is a need for a method for offering partially-refundable vouchers for goods or services, as described herein.

### BRIEF SUMMARY OF THE INVENTION

To meet the needs described above and others, the present disclosure provides systems and methods for generating partially-refundable vouchers for goods or services.

Specifically, the present system provides an alternative for potential purchasers of a good or service, potential purchasers who are concerned that in the future he or she may regret making the purchase of the good or service. The system generates a voucher value related to a voucher that, if purchased, may be redeemed for a limited time for a given good or service, or group of goods or services. The voucher may include a refund value, such that should the purchaser decide not to redeem the voucher for the goods or services, the refund value indicates the value that may be returned to the purchaser.

The present system enables a person to pay a fee to acquire a generated voucher that may be exchanged for a predetermined good or service at some point in the future. The voucher value (or voucher price) that a consumer pays is generated by the system and method disclosed herein, and does not necessarily reflect current market prices at time of purchase. Instead, the voucher value generated by the system may include both a built-in profit margin, as well as buffer to protect against rising prices in the future.

In a given transaction, there is a seller of goods and/or services and a buyer (i.e., voucher redeemer), There are situations in which the seller of goods and/or services will provide the voucher. In those situations, the seller may bear the risk that the transaction value at the time of the voucher redemption will exceed the voucher value. However, there are other situations in which the voucher will be provided by a third party. In those situations, the third-party may bear the risk that the transaction value at the time of the voucher redemption exceed the voucher value by assuring the seller gets the full transaction value at the time of the voucher redemption. This can be accomplished several ways. In a first, the third party pays the voucher redeemer the difference between the voucher value and the full transaction value at the time of the voucher redemption. In another example, the third party pays the seller the difference between the voucher value and the full transaction value at the time of the voucher redemption. In another example, the third party may pay the full transaction value to the seller at the time of the voucher redemption in exchange for retaining the voucher value from the redeemer.

The objective of the invention is to provide a solution to the frustration consumers often face when they are pressured to decide on purchasing a good or service before they are confident they will ultimately wish to use or consume the good. This pressure may stem from many sources, with limited quantity, variable pricing, and difficult or expensive returns and exchanges being among them. Currently, an available solution for this dilemma is the “option”. The most common options are stock options, which a person may pay for a right to buy a stock a given price for a predetermined period of time. This type of product, while also addressing the frustrations of partially refundable vouchers, is not one that many people are familiar with or encounter on a day-to-day basis. For consumer goods and services, the presentation and sale of an option is a foreign concept that is not easily marketed or understood. Consumers, on the other hand, are familiar with the concept of vouchers and how vouchers may be purchased and subsequently redeemed for goods and services. With vouchers, a consumer knows once a purchase is made, he has the right to redeem it for a given good or service, and no thought or mention of price is required again. In the present system, if the voucher isn't redeemed, a portion of the purchase price is returned to the user. This concept is not unlike purchasing an article of clothing online and paying a shipping price to have item delivered to your home. Here the consumer understands that if garment doesn't fit it can be returned for full price, but the shipping payment will not be returned. These sorts of transactions are familiar to many consumers, which is what makes the partially refundable voucher system accessible and necessary.

The present disclosure provides a system including a controller and a memory coupled to the controller, wherein the memory is configured to store program instructions executable by the controller. In response to executing the program instructions, the controller is configured to receive via a user interface information associated with a transaction, and generate a voucher value for a voucher associated with the transaction based on the information received from the user interface. In addition, the controller is configured to generate a refund value of the voucher based on the voucher value, and generate an expiration date of the voucher based on the voucher value and at least one date associated with the transaction. The controller also may display the voucher value, expiration date, and refund value on the user interface associated with a consumer of the transaction.

In an example, the controller is further configured to access a database of values including at least one of a historical market value associated with the transaction, a forecast market value associated with the transaction, or a current market value of the transaction. In such example, the voucher value may be based on the received information, the historical market value of the transaction, the current market value associated with the transaction, the forecast market value associated with the transaction, or combinations thereof.

In yet another example, the voucher value is based on at least one of a profit-margin associated with the transaction, a demand associated with the transaction, a supply associated with the transaction, the expiration date, or combinations thereof.

In an example, the information includes an event date, a location, or combinations thereof. Alternatively, or in addition to, the information includes a departure date, a return date, a departure location, a destination location, or combinations thereof. The departure date and return date are independently a single date, a range of consecutive dates, at least two nonconsecutive dates, or combinations thereof. In yet another example, the information includes a type of good, a quantity of good, or combinations thereof.

The expiration date may be based on the refund value. The refund value may be based on the voucher value, the expiration date, a risk associated with the voucher, a cost of offering the voucher, a profit margin associated with the transaction, or combinations thereof.

The controller may be further configured to accept payment information via the user interface for the purchase of the voucher. In another example, the controller may be configured to receive confirmation that the voucher has been redeemed, wherein, if the controller does not receive confirmation by the expiration date, the controller is configured to refund the consumer the refund value. The controller may configured to receive confirmation from a business associated with the transaction, a consumer associated with the transaction, or both.

The present disclosure also provides a method including receiving via a user interface information associated with a transaction, wherein the information is selected from the group consisting of departure date, return date, departure location, destination location, and combinations thereof. The method further includes generating a voucher value for an voucher associated with the transaction, and generating a refund value based on the voucher value. The method also includes generating an expiration date of the voucher, wherein the expiration date is based on the voucher price and at least one date associated with the transaction, and displaying the voucher value, expiration date, and refund value on a user interface associated with a consumer of the transaction.

The voucher value may be based on a profit-margin associated with the transaction, a length of time a consumer has to redeem the voucher, or combinations thereof. The voucher value may be based on the historical market value of the transaction, the current market value of the transaction, a forecast market value associated with the transaction, or combinations thereof. The refund value may be based on a risk associated with the voucher, a cost of offering the voucher, a profit margin associated with the transaction, or combinations thereof.

The method may further include accepting payment information via the user interface for the purchase of the voucher. The method may also include refunding the refund value to the consumer if the voucher was not redeemed by the expiration date.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a schematic of an embodiment of the system disclosed herein including a controller, a memory, a user interface, and a database.

FIG. 2A is an example of a voucher produced by the system disclosed herein.

FIG. 2B is an example of a voucher produced by the system disclosed herein.

FIG. 3 is a schematic of an embodiment of the system disclosed herein depicting the interaction between the user information and controller in order to produce a voucher.

FIG. 4 is a flowchart of an embodiment of the method of producing a voucher as disclosed herein.

FIG. 5 is a flowchart of an embodiment of the method of producing a voucher as disclosed herein.

### DETAILED DESCRIPTION OF THE INVENTION

The present disclosure provides systems 10 and methods 11 of generating a voucher 20 associated with a transaction 21 based on information 22 provided by the user and data stored in a database 18 or otherwise accessed by the controller 12.

As shown in FIG. 1, the present system 10 includes a controller 12 and a memory 14 coupled to the controller 12, wherein the memory 14 is configured to store program instructions executable by the controller 12. In response to executing the program instructions, the controller 12 is configured to receive via a user interface 16 information 22 associated with a transaction 21. The system 10 generates a voucher value 24 for a voucher 20 associated with the transaction 21 based on the information 22 received from the user interface 16. Typically, the voucher value 24 is the purchase price of the voucher 20 associated with a particular transaction 21.

In an example, the information 22 received by the controller 12 includes an event date 30, a location 44, or combinations thereof. For example, a consumer may be interested in purchasing a voucher 20 to attend a certain musical playing at a particular theatre location 44 over a range of dates 30. The location 44 may be selected as specific theatres, arenas, venues, neighborhoods, towns, states, zip codes, among others. The event date 30 may be a singular date, consecutive dates, non-consecutive dates, or combinations thereof.

Alternatively, or in addition to, the information 22 may include a departure date 46, a return date 48, a departure location 50, a destination location 52, or combinations thereof. For example, a consumer may be interested in purchasing a voucher 20 relating to travel, such as flight, train, bus, or other transportation vouchers. As a result, a consumer may purchase a voucher 20 relating to an upcoming trip for which the exact departure date 46 or return date 48 are not finalized at the time of the voucher purchase. For example, the departure date 46 and return date 48 may be independently a single date, a range of consecutive dates, at least two nonconsecutive dates, or combinations thereof. Alternatively, a voucher 20 may be generated based on information 22 including an identified departure date 46 and a return date 48, but with a departure location 50 and destination location 52 that may include more than two locations. In other words, the system 10 provides consumers a voucher 20 having a specific voucher value 24 that a consumer may purchase for travel arrangements that are flexible and may be finalized in the future.

For example, a voucher 20 for a flight from an identified departure location 50 and destination location 52 may indicate that the consumer does not need to determine the ultimate travel dates 30 for the flight in question at the time of voucher purchase. Instead, the voucher 20 may be redeemable on flights over a range of travel dates. The travel dates 30 may be consecutive, such as March 1 through March 15 for a departure date 46 or return date 48, or the travel dates 30 may be nonconsecutive, such as March 1, March 6, March 10, or March 15. The travel dates 30 may also be a combination of consecutive and nonconsecutive dates.

In yet another example, the information 22 includes a type of good 54, a quantity of good 56, or combinations thereof. For example, a consumer may be interested in purchasing a voucher for consumer goods or commodities that have prices that vary over time. A consumer may purchase a voucher 20 to buy one hundred pounds of gold on a certain date, which essentially locks in the consumer's purchasing price regardless of the value of gold on the date of purchasing the gold or completing the transaction.

As shown in FIG. 3, the controller 12 is further configured to access a database 18 of values 19 including at least one of a historical market value 32 associated with the transaction 21, a forecast market value 34 associated with the transaction 21, or a current market value 36 of the transaction 21. In such example, the voucher value 24 may be based on the received information 22, the historical market value 32 of the transaction 21, the current market value 36 associated with the transaction 21, the forecast market value 34 associated with the transaction 21, or combinations thereof. In other words, the controller 12 may generate the voucher value 24 based on any number of relevant quantitative values 19, wherein the values 19 are either provided by the consumer, stored in a database 18 accessed by the controller 12, or otherwise accessed by the controller 12. Other examples of values 19, include economic values, such as, the price and/or price movements of securities, other financial instruments, interest rates, etc., which may provide a means for forecasting future price movements related to the transaction 21.

In yet another example, the voucher value 24 is based on at least one of a profit-margin 38 associated with the transaction 21, a demand 40 associated with the transaction 21, a supply 42 associated with the transaction 21, the expiration date 28, or combinations thereof. For example, if the controller 12 determines the demand 40 is relatively high compared to historical demand data, then the controller 12 may generate a voucher value 24 that is higher and reflects the current or projected demand 40 surrounding the transaction 21. Alternatively, if the controller 12 determines a large supply 42 relative to the historical supply data, the controller 12 may generate a voucher value 24 that is lower and reflects the surplus surrounding the transaction 21. The demand 40 and supply 42 values 19 can be measured with any number of auction formats, or by enabling owners of the vouchers 20 to set their own prices and offer them for sale on an exchange. Alternatively, historical and projected demand 40 and supply 42 values 19 may be stored in the database 18 accessed by the controller 12.

In addition, the controller 12 is configured to generate a refund value 26 of the voucher 20 based at least on the voucher value 24. The refund value 26 may also be based on the expiration date 28, a risk associated with the voucher 20, a cost of offering the voucher 20, a profit margin 38 associated with the transaction 21, or combinations thereof. The refund value 26 may also be based on the received information 22, the historical market value 32 of the transaction 21, the current market value 36 associated with the transaction 21, the forecast market value 34 associated with the transaction 21, or combinations thereof.

The controller 12 is configured to generate an expiration date 28 of the voucher 20 based on the voucher value 24 and at least one date 30 associated with the transaction 21. Alternatively, or in addition to, the expiration date 28 may be based on the refund value 26. In addition, the consumer may select an expiration date 28, wherein the controller 12 takes into account the selected expiration date 28 in generating the voucher value 24 and/or refund value 26.

The controller 12 may also take into account the generated expiration date 28 and/or refund value 26 in generating the voucher value 24. For example, for an expiration date 28 that provides a consumer with a longer time period for which to redeem the voucher 20, the controller 12 may generate a voucher value 24 that is relatively higher, based on the risk accepted by the organization providing the voucher 20. In another example, the closer the refund value 26 is to the voucher value 24, the closer in time the generated expiration date 28 may be to the date of voucher purchase. Alternatively, a large difference between the voucher value 24 and the refund value 26, may be taken into account in generating the expiration date 28, such that the expiration date 28 is farther in time from the date of voucher purchase.

FIGS. 2A-2B depict examples of vouchers 20 that may be provided to a consumer associated with the transaction 21. FIG. 2A is an example of a generated voucher 20 associated with transaction 21 of a non-stop flight from Milan to Minsk having a departure date 46 of April 10, and a return date 48 of April 15, wherein the voucher 20 is redeemable any time before the expiration date 28 as indicated by the “valid until” value. The voucher value 24 is $500 and the refund value 26 is $490.

FIG. 2B is an example of a generated voucher 20 including terms that are flexible such that a consumer may define the specific terms on or before the day of redemption of the voucher 20. As shown, the departure date 46 may be any time from April 10 to April 15, and the return date 48 may be between April 20 and April 23.

The controller 12 also may display the voucher value 24, expiration date 28, and refund value 26 on the user interface 16 associated with a consumer of the transaction 21. The voucher 20 may be provided to the consumer in a variety of mechanisms, including a user interface 16, email, fax, mail, among others.

The controller 12 may be further configured to accept payment information 58 via the user interface 16 for the purchase of the voucher 20. The payment information 58 may include a consumer's credit card information, bank account information, or other suitable payment method information.

In another example, the controller 12 may be configured to receive confirmation 60 that the voucher 20 has been redeemed, wherein, if the controller 12 does not receive confirmation 60 by the expiration date 28, the controller 12 is configured to refund the consumer the refund value 26. The controller 12 may configured to receive confirmation 60 that the voucher 20 was redeemed from a business associated with the transaction 21, a consumer associated with the transaction 21, or both.

The present disclosure also provides a method 11 including receiving via a user interface 16 information 22 associated with a transaction 21, wherein the information 22 is selected from the group consisting of departure date 46, return date 48, departure location 50, destination location 52, and combinations thereof. The method 11 further includes generating a voucher value 24 for a voucher 20 associated with the transaction 21, and generating a refund value 26 based on the voucher value 24. The method 11 also includes generating an expiration date 28 of the voucher 20, wherein the expiration date 28 is based on the voucher value 24 and at least one date 30 associated with the transaction 21. The method includes displaying the voucher value 24, expiration date 28, and refund value 26 on a user interface 16 associated with a consumer of the transaction 21.

In addition, the method 11 may further include accepting payment information 58 via the user interface 16 for the purchase of the voucher 20. Further, the method 11 may also include refunding the refund value 26 to the consumer if the voucher 20 was not redeemed by the expiration date 28.

FIG. 4 is an example of the method 11 wherein a voucher value 24 is generated by the controller 12. In one implementation of the system 10 that determines a voucher value, historical market prices 32 related to a good or service of the transaction 21 are analyzed to estimate future prices as well as the range of potential future prices. The voucher value 24 estimation may be referred to as “predictive analysis” or “machine learning techniques.” Data analysis of this sort may be used to determine the voucher value 24 and refund value 26. The difference between the voucher value 24 and the refund value 26 may reflect the overall risk of selling the voucher 20, as well as built in expected profit margin 38.

As shown in FIG. 5, the system 10 may include the forces of supply 42 and demand 40 in generating a voucher value 24. Specifically, FIG. 5 is an example of the process with which a voucher value 24 is determined by an exchange-style market.

For example, a consumer wishing to purchase a voucher 20 for an airline ticket transaction 21 may be interested its a route in which current fares are roughly $500 dollars. If the consumer wishes the voucher to be valid for a period of 5 weeks, a voucher may cost $600, to account for the tendency of prices to change in the airline industry. As indicated, the voucher 20 may also include an expiration date 28 indicating a length of time in which it can validly be redeemed for a good or service. To continue with the airline ticket example, a consumer that purchased a voucher 20 with a valid life of 5 weeks may pay more than a consumer who purchases a voucher 20 with a valid life of 3 weeks. After purchasing a voucher 20, a consumer who decides he does not wish to exchange the voucher 20 for a good or service is entitled to a partial refund of the voucher value 24. Similarly, a consumer who allows his voucher 20 to reach expiration will automatically be returned the same partial refund value 26 of the voucher 20.

The refund value 26 may be generated by the system 10 and communicated to the consumer at the time of purchase of the voucher 20. The refund value 26 can be determined by many factors including the risk of price changes, desired profit margin 38 on an individual transaction, supply 42 and demand 40 forces, or other factors. To continue with the airline ticket example, a consumer purchasing a voucher 20 having a voucher value 24 of $500 may be told he has the ability to return his voucher for a refund value 26 of $480.

In one example, the system 10 provides a service for undecided travelers who are not ready to commit to buying an airline ticket. At present an undecided traveler can purchase the ticket now, and risk paying expensive change tees later if the traveler decides not to travel or the undecided traveler can wait to make the ticket purchase, at which point prices may have increased significantly. The present systems enables such a person to purchase a generated voucher 20 which provides both flexibility and peace of mind during the decision making process. The system 10 enables a consumer to pay a quoted price for a voucher 20, say $500, and then allow the consumer three weeks to decide to apply this voucher towards a flight. If in the three weeks following payment of voucher value 24 the consumer decides to redeem the voucher 20 towards a flight, the system 10 will find a ticket meeting the consumer's requirements and provide the consumer with such a ticket. On the other hand, if in the three weeks following purchase of the voucher 20 the consumer does not choose to apply the voucher towards a flight, then $480 will be returned to the consumer. In this example, if the market price for the flight, or collection of flights, in question has increased above the voucher value 24, the consumer may still redeem the purchased voucher 20 and receive the good or service.

In one example, if a consumer buys a voucher having a voucher value 24 of $100 and the market price of a good or service rises to $120 dollars, the consumer may not need to pay any additional amount in order to acquire the good or service in question. In one implementation of the system 10, the company, person, or group of people responsible for the sale of the voucher 20 will be required to supply the difference between the current price and the voucher value 24, or $20.

The voucher 20 may be related to a group of goods or services rather than a single one. The prices associated with a pluralistic voucher 20 can be determined by a computer network or by market forces as described above. In one implementation the voucher 20 may be exchanged for one item out of a collection of items, or it may be redeemable for a collection of items out of an even greater collection of items. For example, a consumer that purchases a voucher 20 for a flight from Milan to Minsk may not know which particular flight he or she will be flying until the voucher 20 is redeemed. In another example, a voucher 20 may be redeemable for five seats as a college football game, and the voucher owner may choose any five available seats in the arena at the time of redemption.

As mentioned above and schematically shown in FIG. 1, aspects of the systems and methods described herein are controlled by one or more controllers 12. The one or more controllers 12 may be adapted to run a variety of application programs, access and store data, including accessing and storing data in the associated databases 18, and enable one or more interactions as described herein. Typically, the controller 12 is implemented by one or more programmable data processing devices. The hardware elements, operating systems, and programming languages of such devices are conventional in nature, and it is presumed that those skilled in the art are adequately familiar therewith.

For example, the one or more controllers 12 may be a PC based implementation of a central control processing system utilizing a central processing unit (CPU), memory 14 and an interconnect bus. The CPU may contain a single microprocessor, or it may contain a plurality of microprocessors for configuring the CPU as a multi-processor system. The memory 14 may include a main memory, such as a dynamic random access memory (DRAM) and cache, as well as a read only memory, such as a PROM, EPROM, FLASH-EPROM, or the like. The system may also include any form of volatile or non-volatile memory 14. In operation, the memory 14 stores at least portions of instructions for execution by the CPU and data for processing in accord with the executed instructions.

The one or more controllers 12 may also include one or more input/output interfaces for communications with one or more processing systems. Although not shown, one or more such interfaces may enable communications via a network, e.g., to enable sending and receiving instructions electronically. The communication links may be wired or wireless.

The one or more controllers 12 may further include appropriate input/output ports for interconnection with one or more output mechanisms (e.g., monitors, printers, touchscreens, motion-sensing input devices, etc.) and one or more input mechanisms (e.g., keyboards, mice, voice, touchscreens, bioelectric devices, magnetic readers, RFID readers, barcode readers, motion-sensing input devices, etc.) serving as one or more user interfaces 30 for the controller 12. For example, the one or more controllers 12 may include a graphics subsystem to drive the output mechanism. The links of the peripherals to the system may be wired connections or use wireless communications

Although summarized above as a PC-type implementation, those skilled in the art will recognize that the one or more controllers 12 also encompasses systems such as host computers, servers, workstations, network terminals, and the like. Further one or more controllers 12 may be embodied in a device, such as a mobile electronic device, like a smartphone or tablet computer. In fact, the use of the term controller 12 is intended to represent a broad category of components that are well known in the art.

Hence aspects of the systems and methods provided herein encompass hardware and software for controlling the relevant functions. Software may take the form of code or executable instructions for causing a controller 12 or other programmable equipment to perform the relevant steps, where the code or instructions are carried by or otherwise embodied in a medium readable by the controller 12 or other machine. Instructions or code for implementing such operations may be in the form of computer instruction in any form (e.g., source code, object code, interpreted code, etc.) stored in or carried by any tangible readable medium.

As used herein, terms such as computer or machine “readable medium” refer to any medium that participates in providing instructions to a processor for execution. Such a medium may take many forms. Non-volatile storage media include, for example, optical or magnetic disks, such as any of the storage devices in any computer(s) shown in the drawings. Volatile storage media include dynamic memory, such as the memory 14 of such a computer platform. Common forms of computer-readable media therefore include for example: a floppy disk, a flexible disk, hard disk, magnetic tape, any other magnetic medium, a CD-ROM, DVD, any other optical medium, punch cards paper tape, any other physical medium with patterns of holes, a RAM, a PROM and EPROM, a FLASH-EPROM, any other memory chip or cartridge, or any other medium from which a controller 12 can read programming code and/or data. Many of these forms of computer readable media may be involved in carrying one or more sequences of one or more instructions to a processor for execution.

It should be noted that various changes and modifications to the presently preferred embodiments described herein will be apparent to those skilled in the art. Such changes and modifications may be made without departing from the spirit and scope of the present invention and without diminishing its attendant advantages.

We claim:

1. A system comprising:
a controller;
a memory coupled to the controller, wherein the memory is configured to store program instructions executable by the controller;
wherein in response to executing the program instructions, the controller is configured to:
receive via a user interface information associated with a transaction;
generate a voucher value for a voucher associated with the transaction based on the information received from the user interface;
generate a refund value of the voucher based on the voucher value;
generate an expiration date of the voucher based on the voucher value and at least one date associated with the transaction; and
display the voucher value, expiration date, and refund value on the user interface associated with a consumer of the transaction.

2. The system of claim 1 wherein the controller is further configured to
access a database of values including at least one of a historical market value associated with the transaction, a forecast market value associated with the transaction, or a current market value of the transaction, and
wherein the voucher value is based on the received information, the historical market value of the transaction, the current market value associated with the transaction, the forecast market value associated with the transaction, or combinations thereof.

3. The system of claim 1 wherein the voucher value is based on at least one of a profit-margin associated with the transaction, a demand associated with the transaction, a supply associated with the transaction, the expiration date, or combinations thereof.

4. The system of claim 1 wherein the information includes an event date, a location, or combinations thereof.

5. The system of claim 1 wherein the information includes a departure date, a return date, a departure location, a destination location, or combinations thereof.

6. The system of claim 5 wherein the departure date and return date are independently a single date, a range of consecutive dates, at least two nonconsecutive dates, or combinations thereof.

7. The system of claim 1 wherein the information includes a type of good, a quantity of good, or combinations thereof.

8. The system of claim 1 wherein the expiration date is further based on the refund value.

9. The system of claim 1 wherein the refund value is based on the voucher value, the expiration date, a risk associated with the voucher, a cost of offering the voucher, a profit margin associated with the transaction, or combinations thereof.

10. The system of claim 1 wherein the controller is further configured to accept payment information via the user interface for the purchase of the voucher.

11. The system of claim 1 wherein the controller is further configured to receive confirmation that the voucher has been redeemed, wherein, if the controller does not receive confirmation by the expiration date, the controller is configured to refund the consumer the refund value.

12. The system of claim 11 wherein the controller is configured to receive confirmation from a business associated with the transaction.

13. The system of claim 11 wherein the controller is configured to receive confirmation from the consumer associated with the transaction.

14. A method of producing a voucher comprising:
receiving via a user interface information associated with a transaction, wherein the information is selected from the group consisting of departure date, return date, departure location, destination location, and combinations thereof;
accessing a database storing a historical market value associated with the transaction, a current market value associated with the transaction, and a forecast market value associated with the transaction;
generating a voucher value for an voucher associated with the transaction;
generating a refund value based on the voucher value;
generating an expiration date of the voucher, wherein the expiration date is based on the voucher value and at least one date associated with the transaction; and
displaying the voucher value, expiration date, and refund value on a user interface associated with a consumer of the transaction.

15. The method of claim 14 wherein the voucher value is based on a profit-margin associated with the transaction, a length of time a consumer has to redeem the voucher, or combinations thereof.

16. The method of claim 14 further comprising accepting payment information via the user interface for the purchase of the voucher.

17. The method of claim 14 wherein
the voucher value is based on the historical market value of the transaction, the current market value of the transaction, a forecast market value associated with the transaction, or combinations thereof,
wherein the refund value is based on a risk associated with the voucher, a cost of offering the voucher, a profit margin associated with the transaction, or combinations thereof.

18. The method of claim 17 further comprising refunding the refund value to the consumer if the voucher was not redeemed by the expiration date.
